(19) United States
(12) Patent Application Publication
(10) Pub. No.: US 2015/0198985 A1
(43) Pub. Date: Jul. 16, 2015

(54) ALTERNATING HARD DRIVE ORIENTATION

(71) Applicant: Lenovo (Singapore) Pte. Ltd., Singapore (SG)

(72) Inventors: Justin Michael Ringuette, Morrisville, NC (US); Nathan J. Peterson, Durham, NC (US); John Scott Crowe, Durham, NC (US); Guillermo Regulez, Wake Forest, NC (US); Amy Leigh Rose, Chapel Hill, NC (US)

(73) Assignee: Lenovo (Singapore) Pte. Ltd., Singapore (SG)

(21) Appl. No.: 14/155,818

(22) Filed: Jan. 15, 2014

(51) Int. Cl. G06F 1/18

(52) U.S. Cl. CPC G06F 1/187

(57) ABSTRACT

An aspect provides a system, including: a processor; a memory operatively coupled to the processor; and a plurality of drives that store data accessible to the processor and each having a. spinning component therein; wherein at least two or more spinning drive components are arranged in an alternating configuration such that at least two spinning drive components take on opposite spin orientations. Other aspects are described and claimed.

### BACKGROUND

Information handling devices (“devices”) come in a variety of forms, for example a server or a data storage device. In some implementations, multiple devices are used together, e.g., in a redundant array of disks (RAID), a server farm, etc., where mountable drives (e.g., hard drives) are inserted into a drive bay (e.g., cage or rack module). Such configurations are often employed such that the drives may be easily (physically) swapped out, e.g., for maintenance on a disk failure, etc.

The mountable drives are mounted within the drive bay by insertion into slots. The drive bay contains connectors, e.g., disposed on backplane of the drive bay, to connect the drives, e.g., to other components such as a controller (e.g., RAID controller), a network connection component, etc.

In such drive bay, the hard drives spin and may cause vibration that is often additive or even synergistic in effect. Thus, dampening or active vibration cancellation is employed to control the physical effects of the spinning drives within the drive bay.

### BRIEF SUMMARY

In summary, one aspect provides a system, comprising: a processor; a memory operatively coupled to the processor; and a plurality of drives that store data accessible to the processor and each having a spinning component therein; wherein at least two or more spinning drive components are arranged in an alternating configuration such that at least two spinning drive components take on opposite spin orientations.

Another aspect provides a method, comprising: alternating spin orientation of mounted drives arranged in slots of a drive bay module.

A further aspect provides a system, comprising: a drive bay having a plurality of slots arranged to hold mountable drives having a spinning component therein in a removable configuration; said slots accommodating an alternating insertion configuration such that at least two mountable drives inserted therein take on opposite spin orientations.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates an example of a drive bay accommodating opposite spin orientations for mountable drives.

FIG. 3 illustrates an example method of alternating drive orientation.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Existing backplane and drive bay designs orient all drives in the same direction on the same plane. For drives having a spinning component, e.g., a hard drive with a spinning platter, this causes torques and sonic revolution forces to be additive, amplifying their impact on components and coupled systems. Existing solutions use dampening or active vibration cancellation in an effort to control the vibration of the

Accordingly, an embodiment provides a drive a plurality of slots arranged to hold mountable drives therein in a removable configuration, with the slots accommodating an alternating insertion configuration such that at least two mountable drives inserted therein take on opposite spin orientations. Another embodiment provides a method of alternating spin orientation of mounted drives arranged in slots of a drive bay, e.g., actively and/or passively.

For example, an embodiment provides a backplane and drive bay, e.g., hard drive cage, which is designed for alternating drive orientations. The drives thus may be mounted top-to-top and/or bottom-to-bottom (i.e., an orientation that alternates the alignment of their spin orientations and reduces vibration), rather than top-to-bottom (i.e., an orientation that aligns their spin orientations and contributes to vibration).

The illustrated example embodiments will be best understood by reference to the figures. The following description is intended only by way of example, and simply illustrates certain example embodiments.

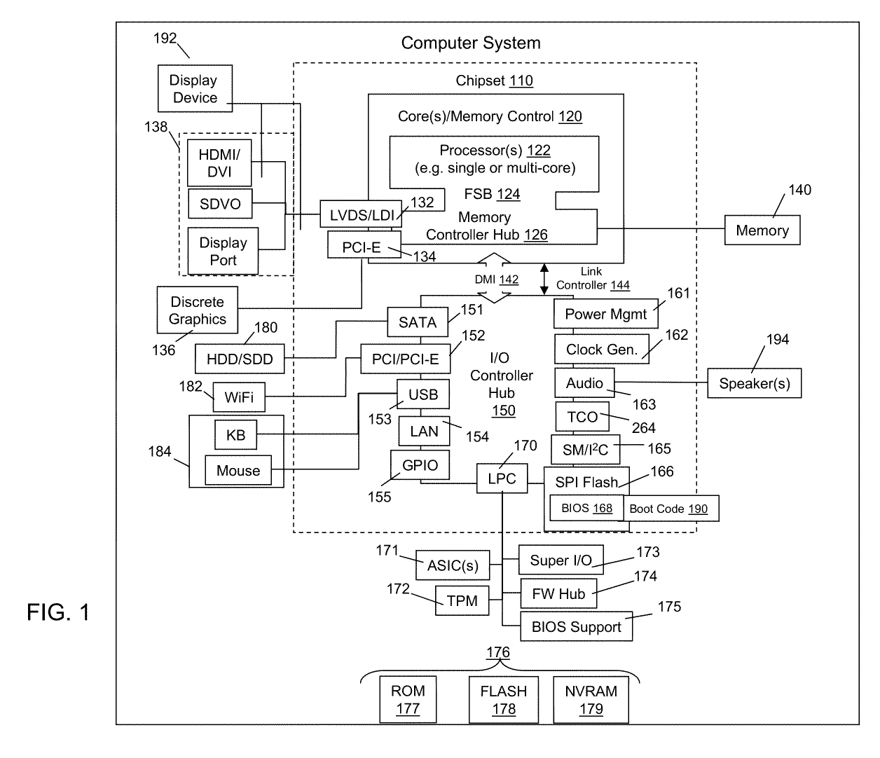

While various other circuits, circuitry or components may be utilized in information handling devices, with regard to the example depicted in FIG. 1 may

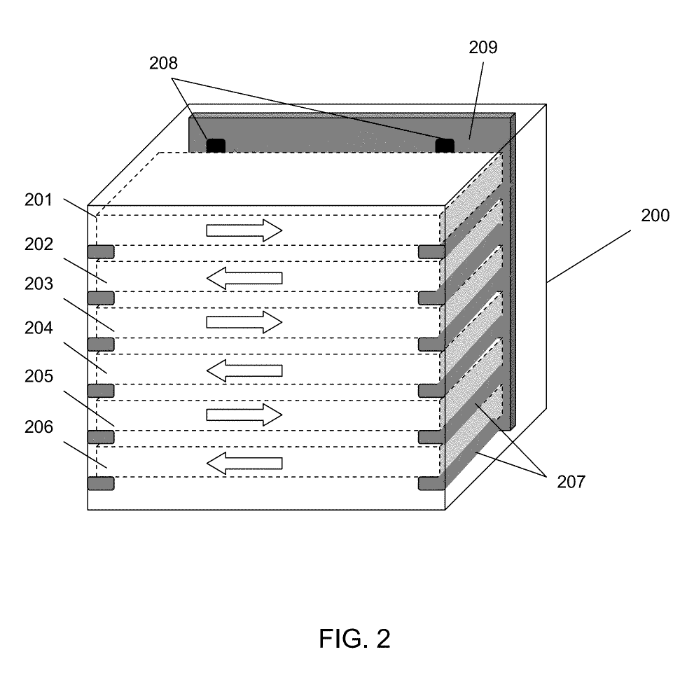

The example of FIG. 1 includes a so-called chipset 110 (a group of integrated circuits, or chips, that work together, chipsets) with an architecture that may vary depending on manufacturer (for example, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 110 includes a core and memory control group 120 and an I/O controller hub 150 that exchanges information (for example, data, signals, commands, etc.) via a direct management interface (DMI) 142 or a link controller 144. In FIG. 2, the DMI 142 is a chip-to-chip interface (sometimes referred to as being a link between a “northbridge” and a “southbridge”). The core and memory control group 120 include one or more processors 122 (for example, single or multi-core) and a memory controller hub 126 that exchange information via a front side bus (FSB) 124; noting that components of the group 120 may be integrated in a chip that

In FIG. 1, the memory controller hub 126 interfaces with memory 140 (for example, to provide support for a type of RAM that may be referred to as “system memory” or “memory”). The memory controller hub 126 further includes a LVDS interface 132 for a display device 192 (for example, a CRT, a flat panel, touch screen, etc.). A block 138 includes some technologies that may be supported via the LVDS interface 132 (for example, serial digital video, HDMI/DVI, display port). The memory controller hub 126 also includes a PCI-express interface (PCI-E) 134 that may support discrete graphics 136.

In FIG. 1, the I/O hub controller 150 includes a SATA interface 151 (for example, for HDDs, SDDs, etc., 180), a PCI-E interface 152 (for example, for wireless connections 182), a USB interface 153 (for example, for devices 184 such as a digitizer, keyboard, mice, cameras, phones, microphones, storage, other connected devices, etc.), a network interface 154 (for example, LAN), a GPIO interface 155, a LPC interface 170 (for ASICs 171, a TPM 172, a super I/O 173, a firmware hub 174, BIOS support 175 as well as various types of memory 176 such as ROM 177, Flash 178, and NVRAM 179), a power management interface 161, a clock generator interface 162, an audio interface 163

The system, upon power on, may be configured to execute boot code 190 for the BIOS 168, as stored within the SPI Flash 166, and thereafter processes data under the control of one or more operating systems and application software (for example, stored in system memory 140). An operating system may be stored in any of a variety of locations and accessed, for example, according to instructions of the BIOS 168. As described herein, a device may include fewer or more features than shown in the system of FIG. 1.

Information handling device circuitry, as for example outlined in FIG. 1, may be included in devices providing a drive that stores data, e.g., hard drive 180 of FIG. 1. FIG. 2 illustrates an example of a drive bay or module 200 that has mounted drives 201-206 inserted into slot positions 207 thereof. According to an embodiment, the drives 201-206 are inserted into the slot positions 207 such that the spin orientations (indicated by the block arrows on the face of each drive) are oriented in an opposite, alternating fashion. This may be accomplished by inserting the drives, rather than a typical top-to-bottom orientation, in a top-to-top or bottom-to-bottom orientation, as illustrated.

This alternating insertion arrangement (noting that fewer than all drives may be oriented in an alternating fashion and/or the alternating pattern may differ from that illustrated) may in turn be accomplished in a variety of ways. For example, in one embodiment, the positioning of a connector 208 for each drive may be alternated for each slot position 207, e.g., alternating it to an apposite side of the bay 200 backplane 209. Alternatively, two connectors 208 may be provided for each slot position 207, i.e., one on each side of the backplane 209 such that no matter which orientation the drive is inserted, it will be connectable.

When the drives 201-206 are inserted such that at leas two of the drives are top-to-top or bottom-to-bottom, as illustrated in FIG. 2, vibration due to having multiple drives spin in the same orientation is reduced. As illustrated in the example of FIG. 2, the drives are inserted such that the spin orientations alternate and thus the spinning drives balance one another, cancelling any rotational forces that contribute to vibration. This avoids the additive effect of the spinning drives contributing to vibration and reduces or eliminates the need to employ dampening mechanisms and/or active vibration control. It should be noted that the example, alternating orientation of the drives illustrated in FIG. 2 is non-limiting. That is, the drives may be vibrationally balanced using other alternating configurations, e.g., two consecutive drives spinning

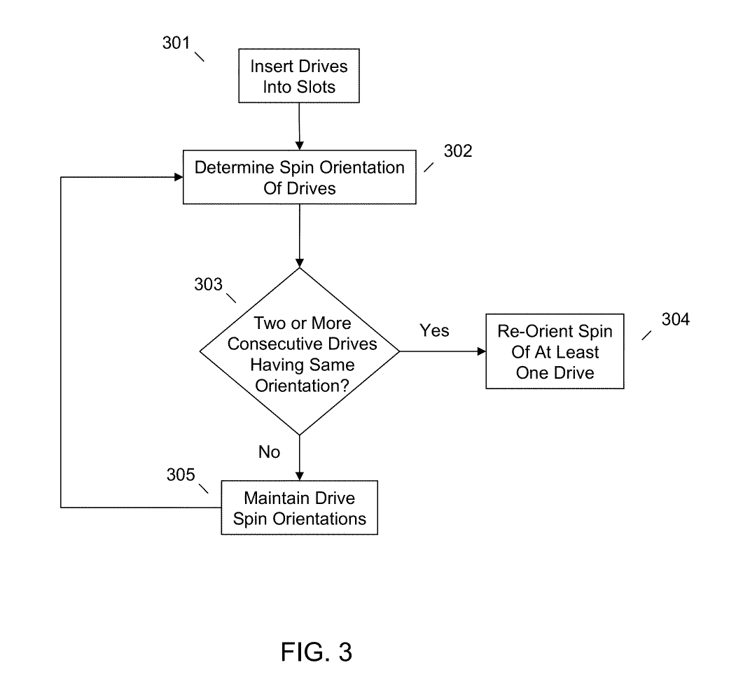

In an embodiment, in addition to, or as an alternative to, inserting drives such that they take on alternating or balanced spin orientations, an embodiment may provide more active control. For example, referring to FIG. 3, for drives which are capable of spinning in more than one orientation, an embodiment may ascertain that multiple or a plurality of drives have been inserted into the drive bay at 301. An embodiment may determine the spin orientation of the drives at 302, i.e., determine in which direction the hard disks are set to spin.

Given this information, an embodiment may determine that the current arrangement or configuration of drives is problematic from the stand point of spin orientations contributing to vibration of the overall unit or system. For example, an embodiment may determine at 303 that two or more consecutive drives have the same spin orientation. If so, an embodiment may suggest or take corrective action.

For example, an embodiment may provide an indication to a user that the current configuration of the drives may cause unwanted vibration. This may take a variety of forms, e.g., a simply indication such as a warning light or a more complete

An embodiment may actively or dynamically correct the drive spin orientations automatically. For example, if it is determined at 303 that two or more consecutive drives have the same spin orientation, an embodiment may re-orient one or more of the drives' spin orientation at 304. This may be accomplished for example by directing a drive to re-orient the direction in which the hard drive platter is spun.

Such determination and/or indicating may be performed at set up time and/or dynamically during use of the system. For example, an embodiment may determine the spin orientations of the drives at installation time and indicate, e.g., to a user installing the drives, that the one or more of the drives should be re-oriented (physically or via setting the spin orientation for the platter(s)). As another example, an embodiment may re-perform this determination and/or indicating during use of the system, e.g., when a drive is replaced. Thus, a user swapping in a new drive may be made aware of the preferred spin orientation for the drive and appropriately insert and/or configure the drive to spin as such.

Thus, an embodiment reduces the vibration of the system via taking into account the spin orientations of the drives inserted into the drive bay. This permits the

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent o those of ordinary skill in the art. The example embodiments were chosen and described in order to explain principles and practical application, and to enable others of ordinary skill in the art to understand the disclosure

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A system, comprising:
a processor;
a memory operatively coupled to the processor; and
a plurality of drives that store data accessible to the processor and each having a spinning component therein;
wherein at least two or more spinning drive components are arranged in an alternating configuration such that at least two spinning drive components take on opposite spin orientations.

2. The system of claim 1, further comprising a drive bay having slots of alternating configuration and including a keyed mount connection configuration such that two consecutive slots orient two consecutively mounted drives in a top-to-top orientation.

3. The system of claim 1, further comprising a drive bay having slots of alternating configuration and including a keyed mount connection configuration such that two consecutive slots orient two consecutively mounted drives in a bottom-to-bottom orientation.

4. The system of claim 1, further comprising a drive bay having slots of alternating configuration, wherein said slots comprise a dual insertion configuration such that sequentially mounted drives inserted therein take on one of an opposite spin orientation and a like spin orientation.

5. The system of claim 1, wherein the at least two or more spinning drive components are arranged via an alternating connection configuration.

6. The system of claim 5, wherein the alternating connection configuration comprises alternating connector orientations for connecting mountable drives.

7. The system of claim 5, wherein the alternating connection configuration comprises more than one connector oriented to accommodate insertion of a mountable drive therein in more than one orientation.

8. The system of claim 1, wherein at least one drive includes at least two connectors.

9. The system of claim 1, further comprising a redundant array of disks (RAID) controller.

10. A method, comprising:
alternating spin orientation of mounted drives arranged in slots of a drive bay module.

11. The method of claim 10, wherein the alternating comprises inserting two or more of the drives into the slots of the drive bay in a top-to-top orientation.

12. The method of claim 10, wherein the alternating comprises inserting two or more of the drives into the slots of the drive bay in a bottom-to-bottom orientation.

13. The method of claim 10, wherein the alternating comprises actively alternating spin direction of a mounted drive.

14. The method of claim 13, wherein actively alternating spin direction of a mounted drive comprises:
determining spin orientation of at least one mounted drive; and
orienting the spin of at least one other mounted drive to be opposite thereto.

15. The method of claim 14, wherein said determining and said orienting are performed during set up of the mounted drives.

16. The method of claim 14, wherein said determining and said orienting are performed automatically during use of the mounted drives.

17. The method of claim 16, wherein at least one of the mounted drives spins in more than one direction.

18. The method of claim 14, wherein said determining and said orienting are performed dynamically during use of the mounted drives.

19. The method of claim 14, further comprising re-performing said determining and said orienting after replacement of at least one of the mounted drives with another mounted drive.

20. A system, comprising:
a drive bay having a plurality of slots arranged to hold mountable drives having a spinning component therein in a removable configuration;
said slots accommodating an alternating insertion configuration such that at least two mountable drives inserted therein take on opposite spin orientations.
